(19) United States
(12) Patent Application Publication
(10) Pub. No.: US 2018/0026488 A1
(43) Pub. Date: Jan. 25, 2018

(54) INDUCED POLARIZATION AC MOTOR

(71) Applicant: I Soo LEE, Seoul (KR)

(72) Inventor: I Soo LEE, Seoul (KR)

(21) Appl. No.: 15/539,948

(22) PCT Filed: Dec. 23, 2015
(86) PCT No.: PCT/KR2015/014208

§ 371 Date: Jun. 26, 2017

(30) Foreign Application Priority Data
Dec. 24, 2014 (KR) 10-2014-0188552

(51) Int. Cl. H02K 3/493; H02K 3/28; H02K 1/22; H02K 15/04

(52) U.S. Cl. CPC H02K 3/493; H02K 15/0485; H02K 3/28; H02K 1/223; H02K 21/32

(57) ABSTRACT

The present invention relates to an induced polarization AC motor having maximized efficiency, a stator of the AC motor being provided with 2n number of winding slots and 2n number of induced polarization slits so that when electricity is applied to the stator having just n number of slots distributedly wound, polarization is induced on the magnetic field surfaces on both sides of the winding slots to double the magnetomotive force for operating and rotating the rotor. Here, the rotational direction is determined by the Fleming left-hand rule.

### TECHNICAL FIELD

The present invention relates to an AC motor with efficiency improved by induced polarization (horse-shoe magnet polarization), and more particularly, to an induced polarization AC motor in which 2n number of winding slots and 2n number of induced polarization slits are provided, and distributed winding is applied only to the n number of winding slots among the 2n number of winding slots, such that polarization is induced, by the induced polarization slits, to magnetic field surfaces at both sides of the winding slots, thereby doubling magnetomotive force, and thus improving efficiency of the motor.

### BACKGROUND ART

One of the global issues that have to be solved by physics in the twenty-first century is an “energy problem”.

AC motors currently use 50% or more of the overall electrical energy.

If a new and innovative technology capable of significantly improving efficiency of the AC motor is developed, the technology can serve to solve the energy problem.

### DISCLOSURE

### Technical Problem

The present invention provides a new and innovative technology capable of significantly improving efficiency of an AC motor.

### Technical Solution

The present invention provides an induced polarization AC motor which includes a stator of the induced polarization AC motor, the stator including: 2n number of winding slots which are provided in a core formed by stacking silicon steel plates; and 2n number of induced polarization slits (horse-shoe magnet polarization slits) which are provided between the winding slots, in which the stator is configured by applying distributed winding only to the n number of winding slots among the 2n number of winding slots, and polarization is induced to magnetic field surfaces at both sides of the winding slots when electricity is applied to the stator, such that a rotor is actuated and rotated by doubling magnetomotive force, and a rotation direction is determined by Fleming's left-hand rule.

### Advantageous Effects [Advantageous Effects] following effects.

1. The motor according to the present invention generates no heat, noise, and vibration.

2. The motor according to the present invention produces no eddy current loss.

3. The motor according to the present invention reduces the number of copper wires by 50% compared to the existing AC motor.

4. The motor according to the present invention improves efficiency by about 200% by doubling magnetomotive force.

5. The motor according to the present invention has no harmonics.

6. The motor according to the present invention produces no windage loss.

### DESCRIPTION OF DRAWINGS

FIG. 1 is a view illustrating a stator according to the present invention.

FIG. 2 is a view illustrating winding slots and induced polarization slits according to the present invention.

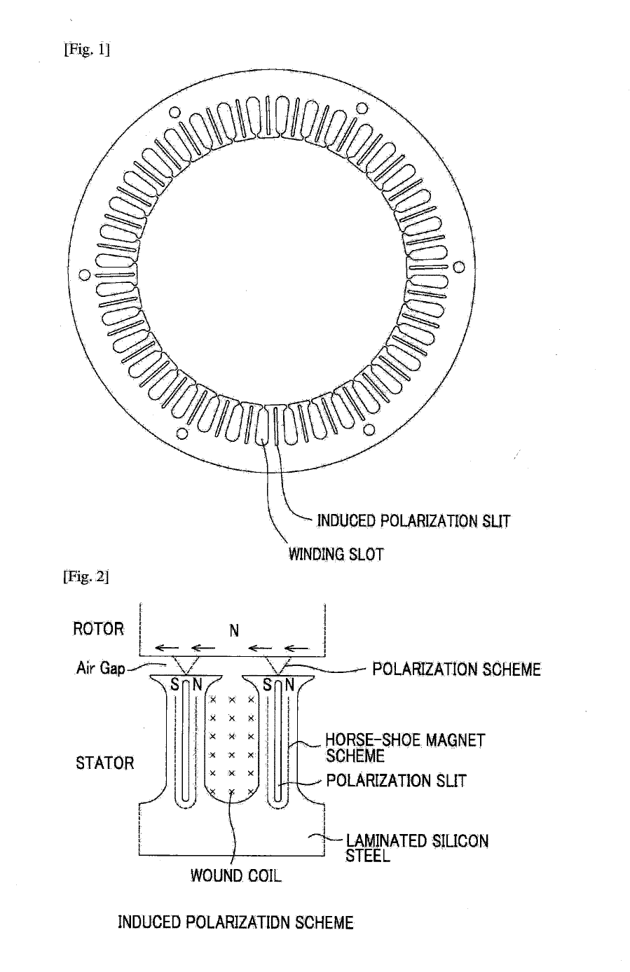

### MODES OF THE INVENTION

The present invention provides an induced polarization AC motor which includes a stator of the induced polarization AC motor, the stator including: 2n number of winding slots which are provided in a core formed by stacking silicon steel plates; and 2n number of induced polarization slits (horse-shoe magnet polarization slits) which are provided between the winding slots, in which the stator is configured by applying distributed winding only to the n number of winding slots among the 2n number of winding slots, and polarization is induced to magnetic field surfaces at both sides of the winding slots when electricity is applied to the stator, such that a rotor is actuated and rotated by doubling magnetomotive force, and a rotation direction is determined by Fleming's left-hand rule.

1. An induced polarization AC motor which includes a stator of the induced polarization AC motor, the stator comprising:
2n number of winding slots which are provided in a core formed by stacking silicon steel plates; and
2n number of induced polarization slits (horse-shoe magnet polarization slits) which are provided between the winding slots_{;}
wherein the stator is configured by applying distributed winding only to the n number of winding slots among the 2n number of winding slots, and polarization is induced to magnetic field surfaces at both sides of the winding slots when electricity is applied to the stator, such that a rotor is actuated and rotated by doubling magnetomotive force, and a rotation direction is determined by Fleming's left-hand rule.
